(19) United States
(12) Patent Application Publication
(10) Pub. No.: US 2024/0304213 A1
(43) Pub. Date: Sep. 12, 2024

(54) HEAD SUSPENSION ASSEMBLY AND DISK DEVICE

(71) Applicants: Kabushiki Kaisha Toshiba, Tokyo (JP); Toshiba Electronic Devices & Storage Corporation, Tokyo (JP)

(72) Inventor: Koji MIYAKE, Sagamihara Kanagawa (JP)

(21) Appl. No.: 18/461,323

(22) Filed: Sep. 5, 2023

(30) Foreign Application Priority Data
Mar. 8, 2023 (JP) 2023-035662

(51) Int. Cl. G11B 5/48

(52) U.S. Cl. CPC G11B 5/4826; G11B 5/4853

(57) ABSTRACT

A head suspension assembly includes a supporting plate, a wiring member that has a gimbal portion and is provided on the supporting plate, and a magnetic head that has a slider having a bonding face opposing the gimbal portion across a gap and a head portion provided on the slider, and is fixed to the gimbal portion with an adhesive positioned between the bonding face and the gimbal portion. A gap region between the bonding face and the gimbal portion includes a first region in which the adhesive is disposed, a second region enclosing the first region, and a third region enclosing the second region. A distance between the bonding face and the gimbal portion in the second region is bigger than a distance between the bonding face and the gimbal portion in the first region and the third region.

### CROSS-REFERENCE TO RELATED APPLICATION(S)

This application is based upon and claims the benefit of priority from Japanese Patent Application No. 2023-035662, filed Mar. 8, 2023, the entire contents of which are incorporated herein by reference.

### FIELD

Embodiments described herein relate generally to a head suspension assembly, and to a disk device including the head suspension assembly.

### BACKGROUND

A hard disk drive (HDD) is an example of a disk device that includes a magnetic disk disposed inside a frame, a magnetic head that carries out recording and reading of information onto and from the magnetic disk, and a head actuator that supports the magnetic head. The head actuator has an actuator block supported in such a way as to pivot freely around a supporting shaft, multiple arms extending from the actuator block, and a head suspension assembly (sometimes called a head gimbal assembly (HGA)) connected to an extended end of each arm.

The magnetic head has a slider, and a recording/reproducing element provided inside the slider. The magnetic head is attached to the suspension assembly by a bonding face of the slider being affixed to a gimbal portion of the suspension.

In order to stabilize vibration properties of the head gimbal assembly (HGA), it is necessary to achieve stabilization of slider bonding. Normally, the slider bonding face is ground smooth in a lapping process, and cleanliness is also managed. Because of this, no surface treatment, such as an application of a primer, that increases adhesive force is carried out. In order to stabilize slider bonding, an adhesive application position and a bonding area are preferably constant, but control of an application position, an amount applied, and wetting-out is sometimes difficult.

### DESCRIPTION OF THE DRAWINGS

FIG. 1 is a perspective view showing a hard disk drive (HDD) according to a first embodiment with a top cover removed.

FIG. 2 is a perspective view showing an actuator assembly and a substrate unit of the HDD.

FIG. 3 is a perspective view showing a head suspension assembly of the head actuator assembly.

FIG. 4 is an exploded perspective view of the head suspension assembly.

FIG. 5 is a plan view showing a magnetic head side of the head suspension assembly.

FIG. 6 is a plan view of a bonding face of a slider of the magnetic head.

FIG. 7 is a sectional view of the slider along a B-B line of FIG. 6.

FIGS. 8A to 8E are sectional views schematically showing a process of forming a groove in the slider.

FIG. 9 is a sectional view of a magnetic head mounting portion of the head suspension assembly along an A-A line of FIG. 5.

FIG. 10 is a plan view showing a bonding face of a magnetic head in an HDD according to a second embodiment.

FIG. 11 is a sectional view of a magnetic head mounting portion of a suspension assembly in the second embodiment.

FIG. 12 is a plan view showing a bonding face of a magnetic head in an HDD according to a third embodiment.

FIG. 13 is a sectional view of a magnetic head mounting portion of a suspension assembly in the third embodiment.

FIG. 14 is a plan view showing a bonding face of a magnetic head in an HDD according to a fourth embodiment.

FIG. 15 is a sectional view of a magnetic head mounting portion of a suspension assembly in the fourth embodiment.

FIG. 16 is a plan view showing a magnetic head mounting region of a suspension assembly in an HDD according to a fifth embodiment.

FIG. 17 is a sectional view of a magnetic head mounting portion of a suspension assembly in the fifth embodiment.

### DETAILED DESCRIPTION

Embodiments provide a head suspension assembly that employs an adhesive with controllable fluidity such that bonding of a magnetic head can be stabilized, and a disk device that includes the head suspension assembly.

In general, according to one embodiment, a head suspension assembly includes a supporting plate, a wiring member that has an elastically deformable gimbal portion and is provided on the supporting plate, and a magnetic head that has a slider having a bonding face opposing the gimbal portion and a head portion provided on the slider, and is fixed to the gimbal portion with an adhesive positioned between the bonding face and the gimbal portion. A gap region between the bonding face and the gimbal portion includes a first region in which the adhesive is disposed, a second region enclosing the first region, and a third region positioned enclosing the second region, and a distance between the bonding face and the gimbal portion in the second region is bigger than a distance between the bonding face and the gimbal portion in the first region and the third region.

Hereafter, a disk device according to embodiments will be described, while referring to the drawings. The present disclosure is an example, and appropriate changes easily devised by those skilled in the art without departing from the scope of the disclosure are included in the scope of the disclosure. Also, in order to further clarify the description, a width, a thickness, a form, and the like of each portion are shown schematically in the drawings, but this is also an example, and does not limit the scope of the disclosure. Also, in the specification and the drawings, identical reference signs are assigned to components previously described in relation to a previously described drawing, and a detailed description thereof is omitted as appropriate.

### First Embodiment

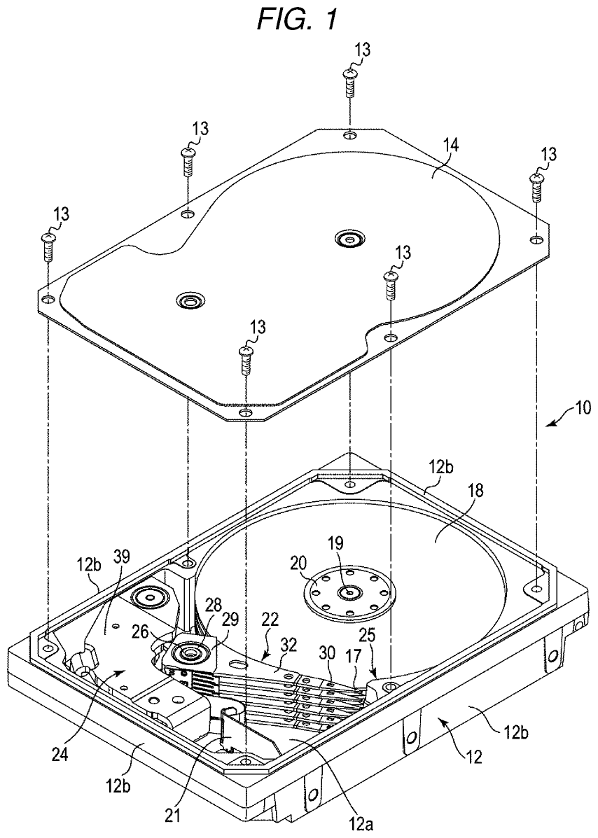

A hard disk drive (HDD) according to a first embodiment will be described in detail as a disk device. FIG. 1 is an exploded perspective view of the HDD according to the first embodiment shown with a top cover removed. As shown in FIG. 1, the HDD includes a rectangular frame 10. The frame 10 has a rectangular box-form base 12, whose upper face is opened, and a cover 14. The base 12 has a rectangular bottom wall 12a, and a side wall 12b provided upright following a peripheral edge of the bottom wall 12a, and is molded in an integrated manner from, for example, aluminum. The cover 14 is formed in a rectangular plate form from, for example, stainless steel. The cover 14 is screwed onto the side wall 12b of the base 12 using a multiple of screws 13, and hermetically closes an upper opening of the base 12.

Inside the frame 10, a multiple, five for example, of magnetic disks 18 is provided as disk-form recording media, and a spindle motor 19 that supports the magnetic disks 18 and causes the magnetic disks 18 to rotate is provided. The spindle motor 19 is disposed on the bottom wall 12a. Each magnetic disk 18 has a non-magnetic body, a substrate formed of glass for example, formed in a disk form with a diameter of, for example, 95 mm (3.5 inches), and a magnetic recording layer formed on an upper face and a lower face of the substrate. The magnetic disks 18 are fitted coaxially with each other on a hub of the spindle motor 19, and furthermore, are clamped with a clamp spring 20. Because of this, the magnetic disks 18 are supported parallel to each other across a predetermined interval, and approximately parallel to the bottom wall 12a. The magnetic disks 18 are rotated at a predetermined speed of rotation by the spindle motor 19. The number of magnetic disks 18 is not limited to five and may be ten or more, twelve or less.

A multiple of magnetic heads 17, which carry out a recording and a reproduction of information onto and from the magnetic disk 18, and an actuator assembly 22, which supports the magnetic heads 17 in such a way as to move freely with respect to the magnetic disk 18, are provided inside the frame 10. Also, a voice coil motor (VCM) 24, which pivots and positions the actuator assembly 22, a ramp loading mechanism 25, which holds the magnetic head 17 in an unloaded position separated from the magnetic disk 18 when the magnetic head 17 moves to an outermost periphery of the magnetic disk 18, and a substrate unit 21 on which an electronic part such as a conversion connector is mounted, are provided inside the frame 10. The VCM 24 includes a pair of yokes 39 provided on the bottom wall 12a, and a magnet (not shown) fixed to the yoke 39. The ramp loading mechanism 25 includes a ramp (not shown) provided upright on the bottom wall 12a. A printed circuit board (not shown) is screwed to an outer face of the bottom wall 12a of the base 12. The printed circuit board is a control circuit that controls an operation of the spindle motor 19, and controls an operation of the VCM 24 and the magnetic head 17 via the substrate unit 21.

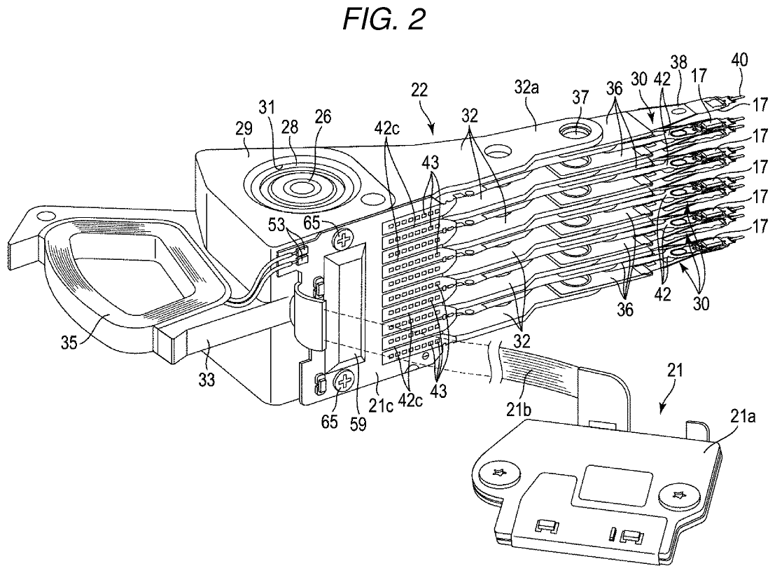

FIG. 2 is a perspective view showing an actuator assembly and a substrate unit. As shown in the drawing, the actuator assembly 22 includes an actuator block 29 having a through hole 31, a bearing 28 provided inside the through hole 31, a multiple, six for example, of arms 32 extending from the actuator block 29, a suspension assembly (also called a head gimbal assembly (HGA)) 30 attached to each arm 32, and the magnetic head 17, which is supported by the suspension assembly 30. A supporting shaft (e.g., an axle) 26 is provided upright on the bottom wall 12a of the base 12. The actuator block 29 is supported by the bearing 28 in such a way as to pivot freely around the supporting shaft 26.

In the present embodiment, the actuator block 29 and the six arms 32 are formed in an integrated manner with aluminum or the like, and are commonly referred to as an E-block. Each arm 32 is formed in, for example, an elongated flat plate form, and extends from the actuator block 29 in a direction perpendicular to the supporting shaft 26. The six arms 32 are provided parallel to each other across a gap. The actuator assembly 22 has a supporting frame 33 extending from the actuator block 29 in a direction opposite to that of the arms 32. A voice coil 35 that makes up one portion of the VCM 24 is supported by the supporting frame 33. The voice coil 35 is positioned between the pair of yokes 39, one of which is fixed, on the base 12, and make up the VCM 24 together with the yokes 39 and the magnet fixed to the yokes 39.

As shown in FIG. 2, the actuator assembly 22 includes ten head suspension assemblies 30, each of which supports the magnetic head 17. The head suspension assembly 30 is attached to a leading end portion 32a of each arm 32. The multiple of head suspension assemblies 30 include a head-up suspension assembly, which supports the magnetic head 17 oriented upward, and a head-down suspension assembly, which supports the magnetic head 17 oriented downward. The head-up suspension assembly and the head-down suspension assembly are configured by disposing head suspension assemblies 30 of the same structure with differing up-down orientations. In the present embodiment, in FIG. 2, the head-down suspension assembly 30 is attached to the uppermost arm 32, and the head-up suspension assembly 30 is attached to the lowermost arm 32. The head-up suspension assembly 30 and the head-down suspension assembly 30 are attached to each of the four intermediate arms 32.

The head suspension assembly 30 has an approximately rectangular base plate 36, a load beam 38 formed of an elongated leaf spring, and an elongated strip-form flexure (which contains wiring and is thus also referred to herein as a wiring member) 42. The flexure 42 has a gimbal portion, to be described hereafter, and the magnetic head 17 is mounted on the gimbal portion. A base end portion of the base plate 36 is fixed to the leading end portion 32a of the arm 32. A base end portion of the load beam 38 is fixed coinciding with a leading end portion of the base plate 36. The load beam 38 extends from the base plate 36, and is formed tapering toward an extended end. The load beam 38 generates a spring force (a reactive force) that biases the magnetic head 17 toward a surface of the magnetic disk 18. A tab 40 protrudes from a leading end of the load beam 38. The tab 40 can be engaged with the aforementioned ramp, and makes up the ramp loading mechanism 25 together with the ramp.

As shown in FIG. 2, the substrate unit 21 includes an approximately rectangular base portion 21a, an elongated strip-form linking portion 21b extending from one side edge of the base portion 21a, and a joint portion 21c provided to be continuous with a leading end of the linking portion 21b. The base portion 21a, the linking portion 21b, and the joint portion 21c are parts of a flexible printed circuit (FPC) board. Electronic parts such as a conversion connector (not shown) and multiple capacitors (not shown) are mounted on the base portion 21a, and electrically connected to wiring (not shown).

The linking portion 21b extends from a side edge of the base portion 21a toward the actuator block 29. The joint portion 21c is of a rectangular form of a height and a width approximately equivalent to those of a side face (an installation face) of the actuator block 29. The joint portion 21c is affixed to the installation face of the actuator block 29 across a backing plate formed of aluminum or the like, and furthermore, is fixed by screwing to the installation face using a fixing screw 65. A multiple of connection pads are provided in the joint portion 21c. One, for example, a head IC (in particular, a head amplifier) 59 is mounted on the joint portion 21c, and the head IC 59 is connected to the connection pad and the base portion 21a via wiring. Furthermore, a connection terminal 53 to which the voice coil 35 is connected is provided in the joint portion 21c.

The flexure 42 of each head suspension assembly 30 has one end portion electrically connected to the magnetic head 17, another end portion extending to the actuator block 29 through a side edge of the arm 32, and a connection end portion (also referred to herein as a tail connection terminal portion) 42c provided in the other end portion. The connection end portion 42c has an elongated rectangular form. A multiple of connection terminals (connection pads) 43 are provided in the connection end portion 42c. Each of the connection pads 43 is connected to wiring of the flexure 42. That is, a multiple of wires of the flexure 42 extend over approximately the whole length of the flexure 42, one end is electrically connected to the magnetic head 17, and another end is connected to the connection terminal (connection pad) 43. The connection pad 43 provided in the connection end portion 42c is joined to the connection pad of the joint portion 21c, and is electrically connected to wiring of the joint portion 21c. Because of this, each of the ten magnetic heads 17 of the actuator assembly 22 is electrically connected to the base portion 21a via the wiring of the flexure 42, the connection end portion 42c, the joint portion 21c of the substrate unit 21, and the linking portion 21b.

The supporting shaft 26 is disposed vertically approximately parallel to a spindle of the spindle motor 19 when the actuator assembly 22 configured as heretofore described is incorporated onto the base 12. Each magnetic disk 18 is positioned between two head suspension assemblies 30. Each of magnetic heads 17 supported by two head suspension assemblies 30 opposes an upper face and a lower face of the magnetic disk 18 when the HDD operates.

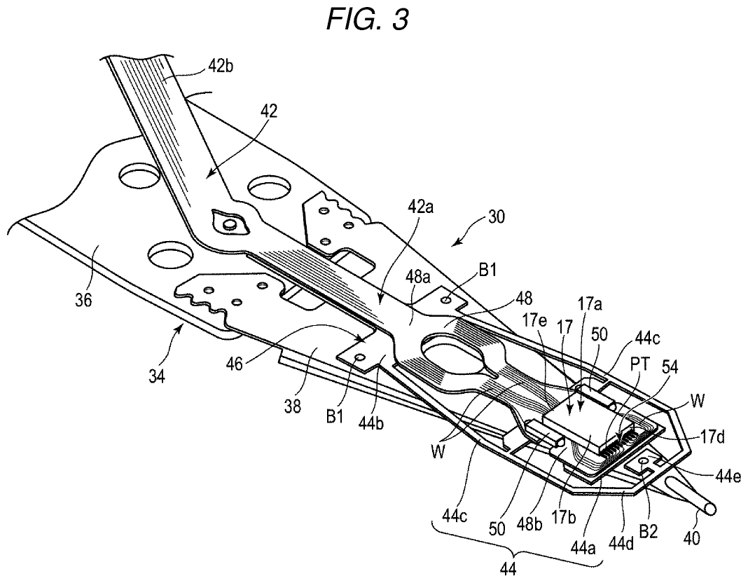

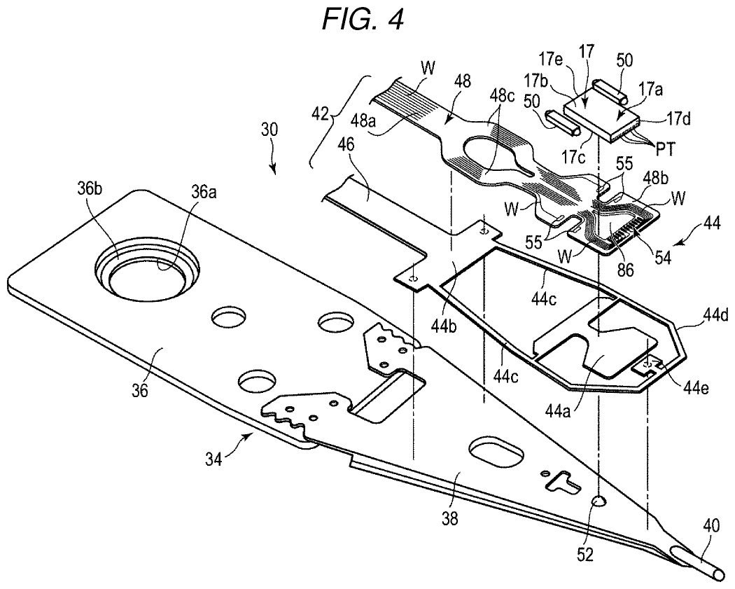

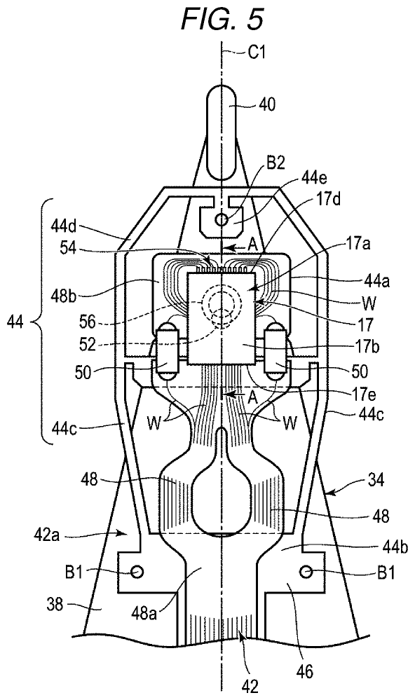

Next, a configuration of the head suspension assembly 30 will be described in detail. FIG. 3 is a perspective view showing a side of a magnetic head of a head suspension assembly, FIG. 4 is an exploded perspective view of the suspension assembly, and FIG. 5 is a plan view of the suspension assembly. As shown in FIGS. 3 and 4, the head suspension assembly 30 has a suspension 34 that functions as a supporting plate. The suspension 34 has the rectangular base plate 36, which is formed of a metal plate with a thickness of several hundred microns, and the elongated leaf spring-form load beam 38, which is formed of a metal plate with a thickness of several tens of microns. The base end portion of the load beam 38 is disposed overlapping with the leading end portion of the base plate 36, and is fixed to the base plate 36 by welding in multiple places. The leading end portion of the load beam 38 configures a leading end portion of the supporting plate. The rod-form tab 40 is disposed protruding from the leading end of the load beam 38.

As shown in FIG. 4, the base plate 36 has a circular aperture 36a in the base end portion thereof, and an annular projecting portion 36b positioned on a periphery of the aperture 36a. The base plate 36 is fastened to the leading end portion 32a of the arm 32 by the projecting portion 36b being fitted into a circular crimping hole (not shown) formed on the arm 32, and the projecting portion 36b being crimped. The base end of the base plate 36 may also be fixed to the leading end portion 32a of the arm 32 by laser welding, spot welding, or bonding.

The suspension assembly 30 has the elongated strip-form flexure (more generally referred to as a wiring member) 42, which is for transmitting a recording signal, a reproduction signal, and a piezoelectric element drive signal, a pair of piezoelectric elements (for example, PZT elements) 50 mounted on the flexure 42, and the magnetic head 17. As shown in FIGS. 2 and 3, the flexure 42 has a leading end side portion 42a disposed on the load beam 38 and the base plate 36, a base end side portion 42b that extends to an outer side from a side edge of the base plate 36 and extends to the actuator block 29 along a side edge of the arm 32, and the connection end portion 42c, which extends from an extended end of the base end side portion 42b. The connection end portion 42c has the multiple connection terminals (connection pads) 43 provided in alignment. The connection pads 43 are electrically joined to a connection terminal of the joint portion 21c installed in the actuator block 29.

As shown in FIGS. 3 to 5, a leading end portion of the flexure 42 is positioned on the leading end portion of the load beam 38 to form a gimbal portion 44 that functions as an elastic supporting portion. The magnetic head 17 is placed on and fixed to the gimbal portion 44, and is supported by the load beam 38 across the gimbal portion 44. The pair of piezoelectric elements 50, which act as drive elements, are mounted on the gimbal portion 44, and are disposed one either side of the magnetic head 17.

The flexure 42 has a thin metal sheet (more generally referred to as a metal plate) 46 of stainless steel or the like, which forms a base, and a strip-form layered member (e.g., a flexible printed circuit board) 48 affixed or fixed onto the thin metal sheet 46, forming an elongated layered plate. The layered member 48 has a base insulating layer, a larger portion of which is fixed to the thin metal sheet 46, a conductive layer (in particular, a wiring pattern), which is formed on the base insulating layer and forms multiple signal wires and drive wires and multiple connection pads, and a cover insulating layer that is stacked on the base insulating layer and covers the conductive layer. Copper foil, for example, is used for the conductive layer, and the multiple signal wires, drive wires, and connection pads are formed by patterning the copper foil. In the leading end side portion 42a of the flexure 42, the thin metal sheet 46 is affixed, or spot welded at multiple welding points, onto surfaces of the load beam 38 and the base plate 36. In one example, the thin metal sheet 46 has two welding points B1 welded to the base end portion of the load beam 38 and one welding point B2 welded to the leading end portion of the load beam 38. That is, the thin metal sheet 46 is welded to the load beam 38 in at least two places, those being the welding point B1 positioned on a leading end side of the magnetic head 17 and the welding point B2 positioned on a trailing end side of the magnetic head 17.

In the gimbal portion 44, the thin metal sheet 46 has a supporting portion including an approximately rectangular tongue portion 44a positioned on a leading end side, an approximately rectangular base end portion 44b positioned on a base end side across a space between the tongue portion 44a and the base end portion 44b, an elastically deformable pair of outriggers 44c, each of which links the base end portion 44b and the tongue portion 44a and supports the tongue portion 44a in such a way as to be displaceable, a linking frame 44d that extends from one outrigger 44c via a leading end side of the tongue portion 44a to the other outrigger 44c, and an approximately rectangular fixing pad portion 44e that extends from the linking frame 44d and opposes a leading end portion of the tongue portion 44a. The fixing pad portion 44e is positioned between the linking frame 44d and the tongue portion 44a. The base end portion 44b is affixed onto the surface of the load beam 38, and spot welded to the load beam 38 at the welding point B1. The fixing pad portion 44e is spot welded to the leading end portion of the load beam 38 at the welding point B2. The welding point B2 is positioned on a central axial line C1 of the suspension 34.

As shown in FIG. 4, the tongue portion 44a is formed to be of a size and form, an approximately rectangular form for example, such that the magnetic head 17 can be placed thereon. The tongue portion 44a is disposed in such a way that a central axial line in a width direction thereof corresponds to the central axial line C1 of the suspension 34. A back end portion of the tongue portion 44a positioned on the base end portion 44b side is linked to the outrigger 44c. An approximate central portion of the tongue portion 44a is in contact with a dimple (more generally referred to as a protruding portion) 52 formed protruding from the leading end portion of the load beam 38. The tongue portion 44a can be displaced into various orientations, with the dimple 52 as a fulcrum, by the pair of outriggers 44c and the linking frame 44d elastically deforming. Because of this, the tongue portion 44a and the magnetic head 17 mounted on the tongue portion 44a are displaced in a rolling direction or a pitching direction, flexibly following a surface fluctuation of the magnetic disk 18, and a minute gap can be maintained between the surface of the magnetic disk 18 and the magnetic head 17.

As shown in FIGS. 3 to 5, the layered member 48 of the flexure 42 is disposed on the metal plate 46 in the gimbal portion 44, and extends from the base end portion 44b to a position on the tongue portion 44a. That is, the layered member 48 has a base end portion 48a affixed onto the base end portion 44b, a leading end portion 48b affixed to the tongue portion 44a, and a pair of strip-form bridge portions 48c extending in a forked form from the base end portion 48a to the leading end portion 48b. The leading end portion 48b makes up a head installation region on which the magnetic head 17 is mounted.

A multiple of connection pads (electrode pads) 54 are provided aligned in a width direction on the leading end portion 48b. Also, a multiple of connection pads (electrode pads) 55 for connecting the piezoelectric element 50 are provided on the leading end portion 48b. The layered member 48 has a multiple of signal wires W, which extend from the connection pad 54 via both side edge portions of the leading end portion 48b to the base end portion 48a side, and a multiple of drive wires W, which extend from the connection pad 55 to the base end portion 48a side. The signal wires W and the drive wires W extend over approximately a whole length of the layered member 48, and are connected to the connection pad 43 of the connection end portion 42c. As shown in FIG. 4, a through hole 86 is provided in a central portion of the leading end portion 48b, particularly in a region in which the wires W do not exist. As will be described hereafter, an adhesive is applied onto the tongue portion 44a via the through hole 86.

The magnetic head 17 has a slider 17a of an approximately flat cuboid form and a head portion (including a recording element (a write head) and a reading element (a read head)) 16 provided in the slider 17a. The slider 17a has an upper face 17b that opposes the surface of the magnetic disk 18 and a lower face 17c on an opposite side, an outflow end 17d positioned on the leading end side of the load beam 38, and an inflow end 17e positioned on the base end portion side of the load beam 38. The magnetic head 17 has multiple connection pads PT provided on the outflow end 17d of the head slider 17a. The connection pads PT are electrically connected to the recording element and the reading element of the magnetic head 17, a heater, and the like.

In a state where the lower face 17c of the slider 17a opposes the leading end portion 48b, the magnetic head 17 is placed overlapping with the leading end portion 48b on the tongue portion 44a, and fixed to the tongue portion 44a using an adhesive. The magnetic head 17 is disposed in such a way that a central axial line in a longitudinal direction coincides with the central axial line C1 of the suspension 34, and an approximate central portion of the magnetic head 17 is positioned on the dimple 52. The connection pad PT of the magnetic head 17 is electrically connected to the multiple connection pads 54 of the leading end portion 48b using a conductive adhesive Sd (shown in FIG. 9) such as a solder or a silver paste. By so doing, the magnetic head 17 is connected to the signal wire W of the layered member 48 via the connection pad 54.

Piezoelectric elements (PZT elements) of, for example, a rectangular plate form are used for the pair of piezoelectric elements 50. The piezoelectric element 50 is disposed in such a way that a longitudinal direction (its expansion direction) thereof is parallel to the central axial line C1 of the suspension 34. The two piezoelectric elements 50 are disposed one on either side in a width direction of the magnetic head 17, and are disposed aligned parallel to each other. Both end portions in the longitudinal direction of each piezoelectric element 50 are mounted on, and electrically connected to, the connection pad 55 of the leading end portion 48b. By so doing, the piezoelectric element 50 is connected to the drive wire W of the layered member 48 via the connection pad 55.

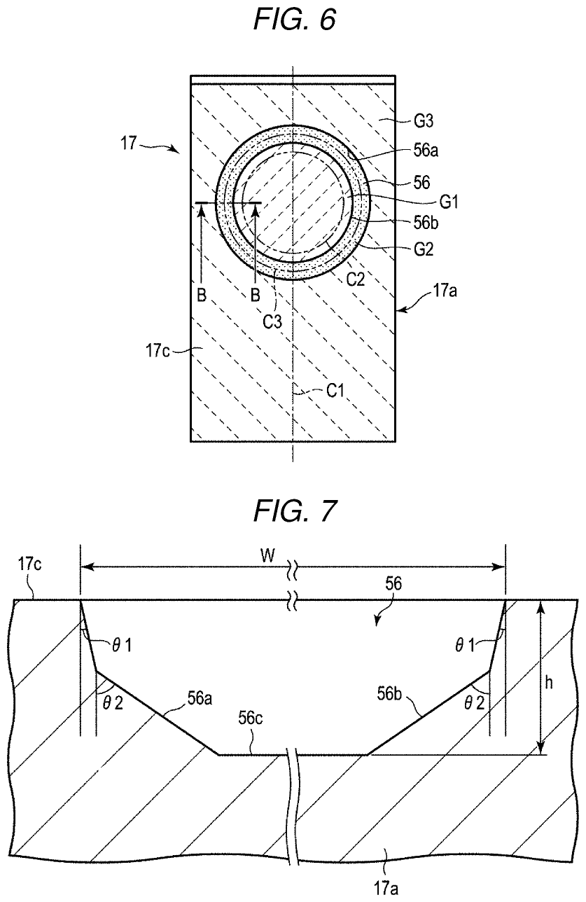

Next, a mounting structure of the magnetic head 17 will be described in detail. FIG. 6 is a plan view showing the bonding face side of the slider 17a of the magnetic head 17, and FIG. 7 is a sectional view of a slider groove portion along a B-B line of FIG. 6. As shown in FIG. 6, the slider 17a has an approximately flat bonding face 17c, and an annular housing groove 56 formed in the bonding face 17c. The housing groove 56 has a form closed in a loop within an area of the bonding face 17c. That is, the housing groove 56 is of a form that is not open on either side edge of the slider 17a. In one example, the housing groove 56 is of an annular form having a center on the central axial line C1. The housing groove 56 has a circular outer periphery and a circular inner periphery when seen in plan view. Also, a depth h of the housing groove 56 is formed to be 2 to 20 μm. In FIG. 6, a two-dotted chain line circle C2 indicates an application region of an adhesive applied to the gimbal portion 44 side. A two-dotted chain line circle C3 indicates an outer peripheral edge of the adhesive after the slider 17a is bonded to the gimbal portion 44.

The housing groove 56 has a cylindrical outer peripheral face 56a, an annular bottom face 56c, and a cylindrical inner peripheral face 56b. As shown in FIG. 7, the outer peripheral face 56a and the inner peripheral face 56b are inclined with respect to a direction perpendicular to the bottom face and the bonding face 17c. In one example, an angle of inclination θ1 of the outer peripheral face 56a and the inner peripheral face 56b on the bonding face 17c side is formed to be 0.79 radians or greater. An angle of inclination θ2 of the outer peripheral face 56a and the inner peripheral face 56b on the bottom face 56c side is formed to be 1.46 radians or greater. In other words, the outer peripheral face 56a and the inner peripheral face 56b have a certain amount of inclination (θ1 and θ2) rather than intersecting the bonding face 17c and the bottom face 56c at right angles. A width W of the housing groove 56 is set to be in the region of 10 to 50 μm.

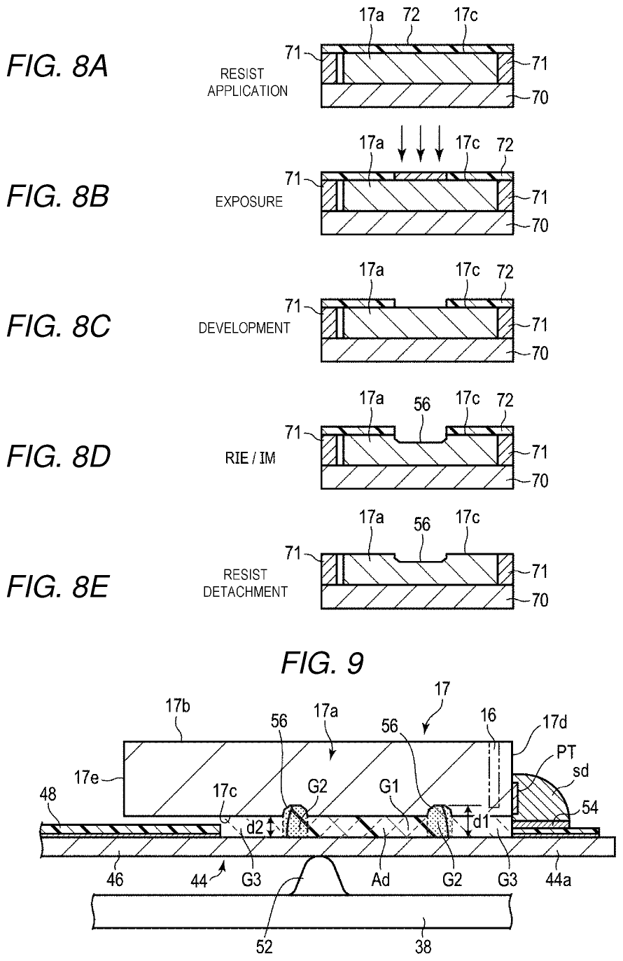

One example of a process of forming the housing groove 56 in the slider 17a will be described. FIGS. 8A to 8E are sectional views schematically showing a groove forming process. As shown in FIG. 8A, the slider 17a is set on a fixing jig 70, and the slider 17a is fixed to the fixing jig 70 using an adhesive 71. Furthermore, a resist is applied to the bonding face 17c of the slider 17a, forming a resist film 72.

Next, after a predetermined region of the resist film 72 is exposed, as shown in FIG. 8B, the exposed region of the resist film 72 is developed and removed, as shown in FIG. 8C. Next, as shown in FIG. 8D, the bonding face 17c of the slider 17a is etched or milled using a reactive-ion etching (RIE) or ion milling (IM) process, forming the housing groove 56 to a depth of in the region of 2 to 20 μm. A lower limit of the groove depth is a minimum depth needed in order to obtain a sufficient advantage. Also, an upper limit of the groove depth is determined with respect to manufacturing time (processing time). Subsequently, as shown in FIG. 8E, the resist film 72 is detached, and furthermore, the slider 17a is removed from the fixing jig 70, whereby the groove forming process ends.

FIG. 9 is a sectional view of a magnetic head mounting portion of a suspension assembly along an A-A line of FIG. 5. As shown in the drawing, the magnetic head 17 is placed on the leading end portion 48b in a state wherein the bonding face 17c of the slider 17a opposes the gimbal portion 44, and is bonded to the tongue portion 44a using an adhesive Ad. In this case, the adhesive Ad is applied to the tongue portion 44a before bonding the magnetic head 17. The adhesive Ad is applied in positions contained on an inner side of a shape of the slider 17a enclosed by the housing groove 56, herein being applied to a region enclosed by the circle C2 shown in FIG. 6. As one example, an acrylic resin-based or an epoxy resin-based adhesive can be used as the adhesive Ad.

When bonding the slider 17a to the tongue portion 44a, the adhesive Ad is sandwiched between the slider 17a and the tongue portion 44a and spreads to an outer side, but as an outer peripheral portion of the adhesive Ad flows into the housing groove 56, the adhesive Ad does not wet-out farther to the outer side than the housing groove 56. As shown by the circle C3 in FIG. 6, and as shown in FIG. 9, an outer peripheral edge of the adhesive Ad after the slider 17a is bonded to the gimbal portion 44 is positioned inside the housing groove 56. Not being limited to a case of flowing into a whole periphery of the housing groove 56, there are also cases wherein an outer peripheral edge of the adhesive Ad is positioned in at least one portion of the housing groove 56.

The connection pad PT of the magnetic head 17 is electrically connected to the multiple of connection pads 54 of the leading end portion 48b using the conductive adhesive Sd, which is as a solder, a silver paste, or the like. By so doing, the magnetic head 17 is connected to the signal wire W of the layered member 48 via the connection pad 54. Also, the approximate central portion of the magnetic head 17 is positioned on the dimple 52.

As shown in FIG. 9, an annular second region G2 including the housing groove 56 encloses a columnar bonding region G1 filled with adhesive in a gap region between the gimbal portion 44 and the bonding face 17c of the slider 17a. Furthermore, a second region G2 is enclosed by a peripheral third region G3. A gap d1 of the second region G2 including the housing groove 56 is wider than a gap d2 of the peripheral third region G3 and a gap d2 of the first region G1, that is, the gap d1 is set to be large. In this way, the second region G2 including the housing groove 56 forms a wide-gapped region wherein the gap is wider than that of the peripheral gap region (the third region G3). The wide-gapped region (the second region G2) encloses the bonding region (the first region G1). This means that when bonding the slider 17a to the gimbal portion 44, the adhesive Ad filling the bonding region G1 is sandwiched between the slider 17a and the tongue portion 44a and spreads to the outer side, but as an outer peripheral edge portion of the adhesive flows into the wide-gapped region G2, the adhesive does not wet-out farther to the outer side than the housing groove 56. As will be described hereafter, the wide-gapped region (the second region G2) can be formed by providing a groove on the gimbal portion side, in the tongue portion 44a for example, instead of providing a groove in the slider 17a.

Meanwhile, when the bottom face of the groove and a peripheral face of the groove are perpendicular to each other in the housing groove 56, the highly viscous adhesive Ad may not reach a corner portion of the bottom face and the side face, and a space is formed. This may form a cause of a decrease in adhesive force or a non-curing of the adhesive. In response to this, according to the present embodiment, the outer peripheral face 56a and the inner peripheral face 56b of the housing groove 56 are provided with a certain amount of inclination (θ1 and θ2) rather than intersecting the bonding face 17c and the bottom face 56c at right angles, as previously described. Because of this, the adhesive Ad can easily reach a corner portion of the housing groove 56, and a creation of a space or a gap can be prevented. Because of this, a decrease in the adhesive force and a non-curing of the adhesive Ad is suppressed.

According to the HDD according to the first embodiment configured as heretofore described, a flow of the adhesive Ad is controlled, and the adhesive Ad can be held in a desired bonding position, by a wide-gapped region (the second region G2) enclosing a bonding region (the first region G1) being provided in a gap between the gimbal portion 44 and the magnetic head 17 in the head gimbal assembly. In the present embodiment, because the annular housing groove 56 forming the wide-gapped region is provided in the slider 17a of the magnetic head, the adhesive Ad flows into the housing groove 56, meaning that the adhesive Ad does not wet-out farther to the outer side than the housing groove 56, and the flow of the adhesive can be controlled with high accuracy. Because of this, the adhesive Ad is held in a desired bonding position, and the magnetic head can be bonded stably to the gimbal portion. Also, because one portion of the adhesive Ad is positioned in the housing groove 56, a bonding area of the adhesive increases, and an increase in adhesive force can be achieved.

According to the present embodiment, the depth of the housing groove 56 is optimized (2 to 20 μm), and furthermore, side faces (the outer peripheral face 56a and the inner peripheral face 56b) of the housing groove 56 have a certain amount of inclination with respect to a direction perpendicular to the bottom face 56c of the housing groove 56, because of which the adhesive Ad can easily reach a corner portion of the housing groove 56 without a space or a gap being created. Because of this, a decrease in the adhesive force and a non-curing of the adhesive Ad is suppressed, and an increase in adhesive force can be achieved. According to the present embodiment, a head suspension assembly (in particular, a head gimbal assembly) in which a magnetic head can be stably bonded and vibration properties can be stabilized, and a disk device that includes the head suspension assembly, can be provided.

Next, a head suspension assembly of an HDD according to another embodiment will be described. In the other embodiment described hereafter, an identical reference sign is assigned to a portion identical to a portion in the first embodiment, a detailed description thereof is omitted or simplified, and a detailed description will be given centered on a portion differing from the first embodiment.

### Second Embodiment

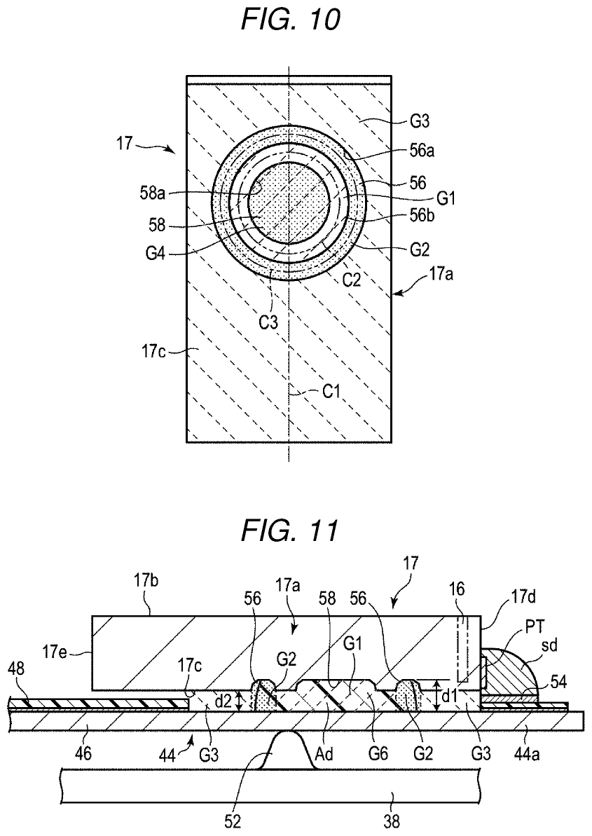

FIG. 10 is a plan view showing a bonding face of a magnetic head in an HDD according to a second embodiment, and FIG. 11 is a sectional view of a magnetic head mounting portion of a suspension assembly in the second embodiment. In the second embodiment, as shown in FIG. 10, the slider 17a of the magnetic head 17 has a circular recess 58 in addition to the annular housing groove 56 formed in the bonding face 17c. The recess 58 has an outer diameter smaller than an inner diameter of the housing groove 56, and is provided concentrically with the housing groove 56 on an inner side of the housing groove 56. The recess 58 has a depth similar to that of the housing groove 56 (2 to 20 μm). The recess 58 is delineated by a circular bottom face and a cylindrical side face. The side face is inclined by angles θ1 and θ2 with respect to a direction perpendicular to the bottom face.

In a gap region between the gimbal portion 44 and the bonding face 17c of the slider 17a, as shown in FIG. 11, the gap d1 of the second region G2 including the housing groove 56 and the gap d1 of a region G6 in which the recess 58 is provided are wider than the gap d2 of the bonding region G1 and the gap d2 of the third region G3 in the periphery of the housing groove 56, that is, the gap d1 is set to be large. In this way, the bonding region G2 including the housing groove 56 and a gap region including the recess 58 each form a wide-gapped region wherein the gap is wider than that of the peripheral gap region G3. The wide-gapped region G2 encloses the bonding region (the first region G1). This means that when bonding the slider 17a to the gimbal portion 44, the adhesive Ad filling the bonding region G1 is sandwiched between the slider 17a and the tongue portion 44a and spreads to the outer side, but as an outer peripheral edge portion of the adhesive flows into the wide-gapped regions (G2 and G6), the adhesive does not wet-out farther to the outer side than the housing groove 56. As shown by the circle C3 in FIG. 10, an outer peripheral edge of the adhesive Ad after the slider 17a is bonded to the gimbal portion 44 is positioned inside the housing groove 56. At the same time, one portion of the adhesive Ad flows into the recess 58, and adheres closely to the bottom face and a side face 58a of the recess 58. Not being limited to a case of flowing into a whole periphery of the housing groove 56, there are also cases wherein an outer peripheral edge of the adhesive Ad is positioned in at least one portion of the housing groove 56.

In the second embodiment, other configurations of the head suspension assembly are the same as the configurations of the head suspension assembly according to the first embodiment. In the second embodiment too, the same operational advantages as in the first embodiment can be obtained. Furthermore, in the second embodiment, the bonding area of the adhesive Ad and the bonding face 17c is increased by the recess 58 being provided in the bonding face 17c of the slider 17a, because of which a further increase in the adhesive force of the adhesive Ad can be achieved.

### Third Embodiment

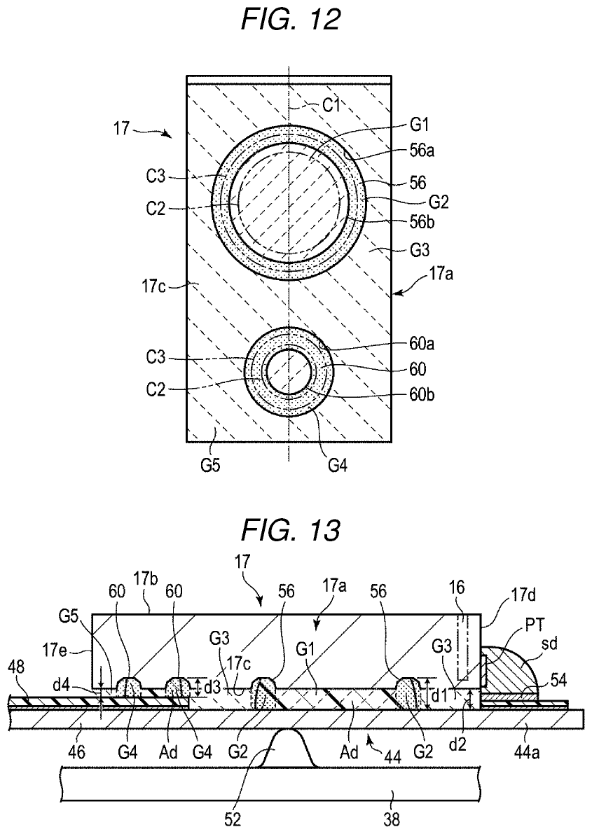

FIG. 12 is a plan view showing a bonding face of a magnetic head in an HDD according to a third embodiment, and FIG. 13 is a sectional view of a magnetic head mounting portion of a suspension assembly in the third embodiment. According to the third embodiment, as shown in FIG. 12, the slider 17a of the magnetic head 17 has an annular second housing groove 60 in addition to the annular housing groove 56 formed in the bonding face 17c. An outer diameter and an inner diameter of the second housing groove 60 are smaller than an outer diameter and the inner diameter of the housing groove 56, and in one example, the outer diameter and the inner diameter of the second housing groove 60 are in the region of approximately 40 to 60% of the outer diameter and the inner diameter of the housing groove 56. A center of the second housing groove 60 is positioned on the central axial line C1 of the slider 17a, and is provided across an interval between the housing groove 56 the second housing groove 60. In one example, the second housing groove 60 is provided in a position overlapping with the layered member 48.

The second housing groove 60 has a depth similar to that of the housing groove 56 (2 to 20 μm). The second housing groove 60 includes an annular bottom face and a cylindrical outer peripheral face 60a and inner peripheral face 60b. Both side faces 60a and 60b are inclined by the aforementioned angles θ1 and θ2 with respect to a direction perpendicular to the bonding face 17c and the bottom face. In FIG. 12, a two-dotted chain line circle C2 indicates an application region of the adhesive Ad applied to the gimbal portion 44 side. A two-dotted chain line circle C3 indicates an outer peripheral edge of the adhesive after the slider 17a is bonded to the gimbal portion 44.

In a state wherein the magnetic head 17 is placed on the gimbal portion 44, the region of the bonding face 17c in which the housing groove 56 is provided opposes the tongue portion 44a, as shown in FIG. 13, and is bonded to the tongue portion 44a using the adhesive Ad. In one example, the region of the bonding face 17c in which the second housing groove 60 is provided opposes the layered member 48, and is bonded to the layered member 48 using the adhesive Ad.

In a gap region between the tongue portion 44a and the bonding face 17c of the slider 17a, the gap d1 of the second region G2 including the housing groove 56 is wider than the gap d2 of the third region G3 positioned in the periphery of the housing groove 56 and the gap d2 of the bonding region G1, that is, the gap d1 is set to be large. In this way, the gap region (the second region G2) including the housing groove 56 forms a wide-gapped region wherein the gap is wider than that of the peripheral gap region (the third region G3). This wide-gapped region encloses the bonding region (the first region G1). This means that when bonding the slider 17a to the tongue portion 44a, the adhesive Ad filling the bonding region G1 is sandwiched between the slider 17a and the tongue portion 44a and spreads to the outer side, but as an outer peripheral portion flows into the wide-gapped region (the second region G2), the adhesive does not wet-out farther to the outer side than the housing groove 56. As shown by the circle C3 in FIG. 12, an outer peripheral edge of the adhesive Ad after the slider 17a is bonded to the tongue portion 44a is positioned inside the housing groove 56. Not being limited to a case of flowing into a whole periphery of the housing groove 56, there are also cases wherein an outer peripheral edge of the adhesive Ad is positioned in at least one portion of the housing groove 56.

Similarly, in a gap region between the layered member 48 and the bonding face 17c of the slider 17a, a gap d3 of a fourth region G4 in which the second housing groove 60 is provided is wider than a gap d4 of a fifth region G5 positioned in a periphery of the second housing groove 60, that is, the gap d3 is set to be large. In this way, the gap region (the fourth region G4) including the second housing groove 60 forms a wide-gapped region wherein the gap is wider than that of the peripheral gap region (the fifth region G5). The wide-gapped region encloses the bonding region. This means that when bonding the slider 17a to the gimbal portion 44, the adhesive Ad is sandwiched between the slider 17a and the layered member 48 and spreads to the outer side, but as an outer peripheral edge portion flows into the wide-gapped region (the fourth region G4), the adhesive Ad does not wet-out farther to the outer side than the second housing groove 60. As shown by the circle C3 in FIG. 12, an outer peripheral edge of the adhesive Ad after the slider 17a is bonded to the gimbal portion 44 is positioned inside the second housing groove 60.

In the third embodiment, other configurations of the head suspension assembly are the same as the configurations of the head suspension assembly according to the above-described first embodiment. In the third embodiment too, the same operational advantages as in the first embodiment can be obtained. Furthermore, according to the third embodiment, the bonding area is increased by bonding places of the magnetic head 17 being increased, and a more stable bonding can be carried out.

### Fourth Embodiment

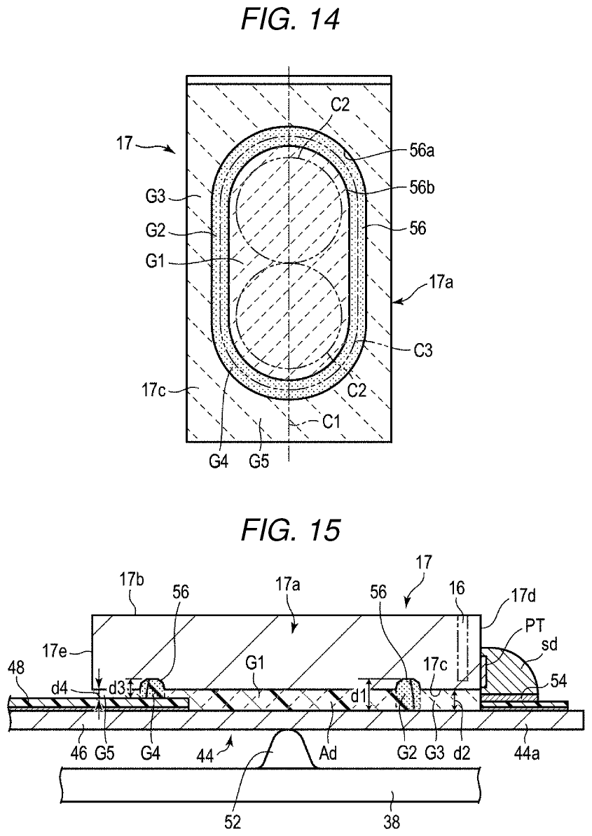

FIG. 14 is a plan view showing a bonding face of a magnetic head in an HDD according to a fourth embodiment, and FIG. 15 is a sectional view of a magnetic head mounting portion of a suspension assembly in the fourth embodiment. In the previously described embodiments, a housing groove of the slider 17a is a groove of an annular form, but a housing groove form not being limited, various other forms, such as an elliptical form, an extended elliptical form, a rectangular form with rounded corners, or a polygonal form, can be selected, provided that the form is closed in a loop.

According to the fourth embodiment, as shown in FIG. 14, the housing groove 56 provided in the bonding face 17c of the slider 17a is of an extended elliptical form or a track form. The housing groove 56 includes a pair of linear portions, extending approximately parallel to the central axial line C1, and a pair of arced portions that link the linear portions. The housing groove 56 extends in an axial direction of the central axial line C1 from a vicinity of one axial direction end of the bonding face 17c to a vicinity of another axial direction end.

The depth of the housing groove 56 is formed to be in the region of 2 approximately to 20 μm. The outer peripheral face 56a and the inner peripheral face 56b of the housing groove 56 are inclined by a predetermined angle (for example, θ2) with respect to a direction perpendicular to the bottom face of the housing groove 56. In FIG. 14, two two-dotted chain line circles C2 each indicate an application region of the adhesive Ad applied to the gimbal portion 44 side. A two-dotted chain line extended ellipse C3 indicates an outer peripheral edge of the adhesive after the slider 17a is bonded to the gimbal portion 44.

In a state wherein the magnetic head 17 is placed on the gimbal portion 44, the region of the bonding face 17c in which the housing groove 56 is provided opposes the tongue portion 44a and the layered member 48, as shown in FIG. 15, and is bonded to the tongue portion 44a and the layered member 48 using the adhesive Ad.

In a gap region between the tongue portion 44a and the bonding face 17c of the slider 17a, the gap d1 of the second region G2 including the housing groove 56 is wider than the gap d2 of the third region G3 positioned in the periphery of the housing groove 56, that is, the gap d1 is set to be large. In this way, the gap region (the second region G2) including the housing groove 56 forms a wide-gapped region wherein the gap is wider than the gap d2 of the peripheral gap region (the third region G3) and the gap d2 of the bonding region G1. This wide-gapped region (the second region G2) encloses the bonding region G1. Also, in a gap region between the layered member 48 and the bonding face 17c of the slider 17a, the gap d3 of the fourth region G4 in which the housing groove 56 is provided is wider than the gap d4 of the fifth region G5 positioned in the periphery, that is, the gap d3 is set to be large. In this way, the fourth region G4 including the housing groove 56 forms a wide-gapped region wherein the gap is wider than that of the peripheral gap region G5. The wide-gapped region (the fourth region G4) encloses the bonding region.

When bonding the slider 17a to the tongue portion 44a and the layered member 48, the adhesive Ad filling the bonding region G1 is sandwiched between the slider 17a and the tongue portion 44a and layered member 48 and spreads to the outer side, but as at least one portion of an outer peripheral edge portion flows into the wide-gapped regions (the second region G2 and the fourth region G4), the adhesive Ad does not wet-out farther to the outer side than the housing groove 56. As shown by the circle C3 in FIG. 14, an outer peripheral edge of the adhesive Ad after the slider 17a is bonded to the tongue portion 44a and the layered member 48 is positioned inside the housing groove 56.

In the fourth embodiment, other configurations of the head suspension assembly are the same as the configurations of the head suspension assembly according to the above-described the first embodiment. Further, in the fourth embodiment too, the same operational advantages as in the first embodiment can be obtained. Furthermore, according to the fourth embodiment, the bonding area of the magnetic head increases, and a more stable bonding can be carried out.

### Fifth Embodiment

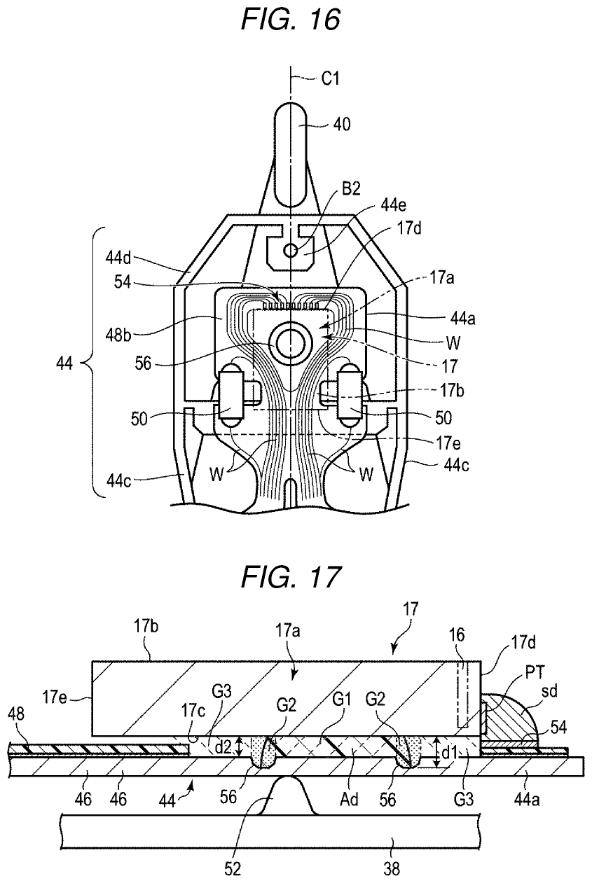

FIG. 16 is a plan view showing a leading end portion and a gimbal portion of a head suspension assembly in an HDD according to a fifth embodiment, and FIG. 17 is a sectional view of a magnetic head mounting portion of a suspension assembly in the fifth embodiment. In the previously described embodiments, a housing groove is provided in the bonding face 17c of the slider 17a, but not being limited to this, a housing groove may also be provided on the gimbal portion 44 side of the head suspension.

According to the fifth embodiment, as shown in FIGS. 16 and 17, the housing groove 56 is provided in the gimbal portion 44, the tongue portion 44a in this case, of the head suspension assembly. The housing groove 56 has the same form and structure as the housing groove 56 in the first embodiment. Specifically, the housing groove 56 has an annular form, and is formed to a depth of 2 to 20 μm. The housing groove 56 has an annular bottom face, and an approximately cylindrical outer peripheral face and inner peripheral face. The outer peripheral face and the inner peripheral face are inclined by predetermined angles θ1 and θ2 with respect to a direction perpendicular to the bottom face.

In a state wherein the magnetic head 17 is placed on the gimbal portion 44, the bonding face 17c of the slider 17a opposes the tongue portion 44a and the layered member 48, as shown in FIG. 17, and is bonded to the tongue portion 44a using the adhesive Ad. The adhesive Ad is applied to an inner side region (the bonding region G1) of the housing groove 56 of the tongue portion 44a before bonding the bonding face 17c. When bonding the slider 17a to the tongue portion 44a, the adhesive Ad is sandwiched between the slider 17a and the tongue portion 44a and spreads to the outer side, but as an outer peripheral portion of the adhesive Ad flows into the housing groove 56, the adhesive Ad does not wet-out farther to the outer side than the housing groove 56.

In a gap region between the tongue portion 44a and the bonding face 17c of the slider 17a, the gap d1 of the second region G2 including the housing groove 56 is wider than the gap d2 of the third region G3 positioned in the periphery of the housing groove 56 and the gap d2 of the bonding region (the first region G1) filled with the adhesive Ad, that is, the gap d1 is set to be large. In this way, the bonding region G2 including the housing groove 56 forms a wide-gapped region wherein the gap is wider than that of the peripheral gap region (the third region G3). This wide-gapped region encloses the bonding region (the first region G1). A configuration wherein the housing groove 56 is provided on the gimbal portion 44 side in this way is also such that a wide-gapped region (the second region G2) enclosing the bonding region (the first region G1) can be formed. When bonding the magnetic head 17, the adhesive Ad is sandwiched between the slider 17a and the tongue portion 44a and spreads to the outer side, but as an outer peripheral edge portion of the adhesive Ad flows into the wide-gapped region (the second region G2), the adhesive Ad does not wet-out farther to the outer side than the housing groove 56.

In the fifth embodiment, other configurations of the head suspension assembly are the same as the configurations of the head suspension assembly according to the above-described first embodiment. Further, in the fifth embodiment too, the same operational advantages as in the first embodiment can be obtained.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A head suspension assembly, comprising:
a supporting plate;
a wiring member that has an elastically deformable gimbal portion and is provided on the supporting plate; and
a magnetic head that has a slider having a bonding face opposing the gimbal portion and a head portion provided on the slider, and is fixed to the gimbal portion with an adhesive positioned between the bonding face and the gimbal portion, wherein
a gap region between the bonding face and the gimbal portion includes a first region in which the adhesive is disposed, a second region enclosing the first region, and a third region enclosing the second region, and a distance between the bonding face and the gimbal portion in the second region is bigger than a distance between the bonding face and the gimbal portion in the first region and the third region.

2. The head suspension assembly according to claim 1, wherein at least one portion of an outer edge portion of the adhesive is positioned in the second region.

3. The head suspension assembly according to claim 1, wherein the second region includes a housing groove formed in the bonding face of the slider, and the housing groove has a closed-loop form and encloses the first region.

4. The head suspension assembly according to claim 3, wherein the housing groove is one of an annular groove, an extended elliptical groove, and a polygonal groove.

5. The head suspension assembly according to claim 3, wherein the housing groove is formed to a depth of 2 to 20 μm.

6. The head suspension assembly according to claim 3, wherein the housing groove has a bottom face, an outer side face, and an inner side face, and the outer side face and the inner side face are inclined with respect to a direction perpendicular to the bottom face.

7. The head suspension assembly according to claim 3, wherein the slider has a recess provided in the bonding face and positioned on an inner side of the housing groove.

8. The head suspension assembly according to claim 1, wherein the second region includes a housing groove formed in the gimbal portion, and the housing groove has a closed-loop form and encloses the first region.

9. A disk device, comprising:
a rotatable magnetic disk;
a head suspension assembly, having a supporting plate, a wiring member, and a magnetic head, wherein
the wiring member has an elastically deformable gimbal portion and is provided on the supporting plate, and
the magnetic head has a slider having a bonding face opposing the gimbal portion and a head portion provided on the slider, and is fixed to the gimbal portion with an adhesive positioned between the bonding face and the gimbal portion, and
a gap region between the bonding face and the gimbal portion includes a first region in which the adhesive is disposed, a second region enclosing the first region, and a third region enclosing the second region, and a distance between the bonding face and the gimbal portion in the second region is bigger than a distance between the bonding face and the gimbal portion in the first region and the third region.

10. The disk device according to claim 9, wherein the second region includes a housing groove formed in the bonding face of the slider, and the housing groove has a closed-loop form and encloses the first region.

11. The disk device according to claim 10, wherein the housing groove is one of an annular groove, an extended elliptical groove, and a polygonal groove.

12. The disk device according to claim 10, wherein the housing groove has a bottom face, an outer side face, and an inner side face, and the outer side face and the inner side face are inclined with respect to a direction perpendicular to the bottom face.

13. The disk device according to claim 9, wherein the second region includes a housing groove formed in the gimbal portion, and the housing groove has closed-loop from and encloses the first region.

14. A disk device, comprising:
a magnetic disk; and
a head gimbal assembly including a gimbal portion and a magnetic head configured to carry out recording and reading of information onto and from the magnetic disk, wherein
the magnetic head includes a slider that is attached to the gimbal portion with an adhesive, and the slider has a surface that includes a first region in contact with the adhesive, a second region surrounding the first region and having a groove formed therein, and a third region surrounding the second region, and
the groove has a bottom face, an outer side face, and an inner side face, and the outer side face and the inner side face are inclined with respect to a direction perpendicular to the bottom face.

15. The disk device according to claim 14, wherein the groove is one of an annular groove, an extended elliptical groove, and a polygonal groove.

16. The disk device according to claim 14, wherein the groove is formed to a depth of 2 to 20 μm.

17. The disk device according to claim 14, wherein the adhesive fills a portion of the groove.

18. The disk device according to claim 17, wherein the bottom face of the groove is completely covered by the adhesive.

19. The disk device according to claim 14, wherein the first region has a recess formed therein and the adhesive fills the recess.

20. The disk device according to claim 14, wherein the third region has another groove formed therein, said another groove surrounding a portion of the surface of the slider that is in contact with another adhesive that is physically separate from the adhesive that the first region is in contact with.
